(19) United States
(12) Patent Application Publication
(10) Pub. No.: US 2015/0365481 A1
(43) Pub. Date: Dec. 17, 2015

(54) MOBILE TERMINAL AND INFORMATION PROCESSING SYSTEM

(71) Applicant: Shuuichi NAKAMURA, Kanagawa (JP)

(72) Inventor: Shuuichi NAKAMURA, Kanagawa (JP)

(73) Assignee: RICOH COMPANY, LTD., Tokyo (JP)

(21) Appl. No.: 14/710,803

(22) Filed: May 13, 2015

(30) Foreign Application Priority Data
Jun. 11, 2014 (JP) 2014-120391

(51) Int. Cl. H04L 29/08

(52) U.S. Cl. CPC H04L 67/141; H04L 67/10

(57) ABSTRACT

A mobile terminal includes a switching unit for selecting a first or second line, when acquiring data from a first information processing apparatus connected to a first network different from that of the mobile terminal, the first line being connected to the first information processing apparatus via a second information processing apparatus connected to a second network to which the mobile terminal is also connected, and the second line being connected to the first information processing apparatus via a third network having a lower communication speed than the first line; and a processing unit configured to send, to the second information processing apparatus, a data acquisition request including a transfer request to transfer to the first information processing apparatus, when the first line is selected, and receive, via the second information processing apparatus, a process result from the first information processing apparatus in response to the data acquisition request.

### BACKGROUND OF THE INVENTION

1. Field of the Invention

The present invention relates to a mobile terminal and an information processing system.

2. Description of the Related Art

In recent years, users have been saving data in an information processing apparatus capable of communication via a network. By connecting various mobile terminals, such as a mobile phone, a smartphone, a tablet terminal, etc., to the information processing apparatus via the network, the user is able to acquire the data saved in the information processing apparatus, and browse the acquired data with the mobile terminal.

For example, there is conventionally known a data communication system including an information communication apparatus, a relay server, and a data server, for communicating data via a network, in which the number of times of performing data communication via the network is reduced, and the traffic amount in the network is reduced (see, for example, Patent Document 1).

Patent Document 1: Japanese Laid-Open Patent Publication No. 2013-254404

Incidentally, when a mobile terminal is connected to an information processing apparatus by a network, the speed of acquiring the data stored in the information processing apparatus is affected by the communication speed of the network. Therefore, when the mobile terminal is connected to an information processing apparatus by a network having a low communication speed, the speed of acquiring the data is reduced, and therefore the performance of acquiring data is degraded.

### SUMMARY OF THE INVENTION

The present invention provides a mobile terminal and an information processing system, in which one or more of the above-described disadvantages are eliminated.

According to an aspect of the present invention, there is provided a mobile terminal for acquiring data from an information processing apparatus, the mobile terminal including a connection destination switching unit configured to select a connection destination between a first line and a second line, when acquiring the data from a first information processing apparatus that is connected to a first network which is different from a network to which the mobile terminal is connected, the first line being connected to the first information processing apparatus via a second information processing apparatus connected to a second network that is the same as the network to which the mobile terminal is connected, and the second line being connected to the first information processing apparatus via a third network having a lower communication speed than that of the first line; and a communication processing unit configured to send, to the second information processing apparatus, a data acquisition request including a transfer request to transfer to the first information processing apparatus, when the first line is selected as the connection destination, and receive, via the second information processing apparatus, a process result of a process executed at the first information processing apparatus in response to the data acquisition request.

According to an aspect of the present invention, there is provided a non-transitory computer-readable recording medium storing a program implementing a mobile terminal for acquiring data from an information processing apparatus, wherein the program causes a computer to execute a process including selecting a connection destination between a first line and a second line, when acquiring the data from a first information processing apparatus that is connected to a first network which is different from a network to which the mobile terminal is connected, the first line being connected to the first information processing apparatus via a second information processing apparatus connected to a second network that is the same as the network to which the mobile terminal is connected, and the second line being connected to the first information processing apparatus via a third network having a lower communication speed than that of the first line; and sending, to the second information processing apparatus, a data acquisition request including a transfer request to transfer to the first information processing apparatus, when the first line is selected as the connection destination, and receiving, via the second information processing apparatus, a process result of a process executed at the first information processing apparatus in response to the data acquisition request.

According to an aspect of the present invention, there is provided an information processing system including a plurality of information processing apparatuses and a mobile terminal for acquiring data from one of the information processing apparatuses, wherein the mobile terminal includes a connection destination switching unit configured to select a connection destination between a first line and a second line, when acquiring the data from a first information processing apparatus that is connected to a first network which is different from a network to which the mobile terminal is connected, the first line being connected to the first information processing apparatus via a second information processing apparatus connected to a second network that is the same as the network to which the mobile terminal is connected, and the second line being connected to the first information processing apparatus via a third network having a lower communication speed than that of the first line, and a communication processing unit configured to send, to the second information processing apparatus, a data acquisition request including a transfer request to transfer to the first information processing apparatus, when the first line is selected as the connection destination, and receive, via the second information processing apparatus, a process result of a process executed at the first information processing apparatus in response to the data acquisition request, wherein the second information processing apparatus includes a transfer processing unit configured to transfer the data acquisition request to the first information processing apparatus, receive, from the first information processing apparatus, the process result of the process executed at the first information processing apparatus in response to the data acquisition request, and transfer the process result to the mobile terminal, when the second information processing apparatus receives, from the mobile terminal, the data acquisition request including the transfer request to transfer to the first information processing apparatus.

### BRIEF DESCRIPTION OF THE DRAWINGS

Other objects, features and advantages of the present invention will become more apparent from the following detailed description when read in conjunction with the accompanying drawings, in which:

FIG. 1 illustrates a configuration of an example of an information processing system according to an embodiment;

FIG. 2 illustrates a hardware configuration of an example of a computer according to an embodiment;

FIG. 3 illustrates a hardware configuration of an example of a mobile terminal according to an embodiment;

FIG. 4 is a process block diagram of an example of the mobile terminal according to an embodiment;

FIG. 5 is a process block diagram of an example of the information processing apparatus according to an embodiment;

FIG. 6 is an image diagram of an example of a registration screen of the information processing apparatus displayed on the mobile terminal;

FIG. 7 is an image diagram of an example of a process of acquiring a file list from the information processing apparatus by the mobile terminal;

FIG. 8 is a sequence diagram of an example of a process of acquiring a file list from the information processing apparatus by the mobile terminal;

FIG. 9 is a flowchart of an example of a process of selecting the connection destination at the mobile terminal; and

FIG. 10 illustrates an example of performance information.

### DETAILED DESCRIPTION OF THE PREFERRED EMBODIMENTS

A description is given, with reference to the accompanying drawings, of embodiments of the present invention.

### First Embodiment

### System Configuration

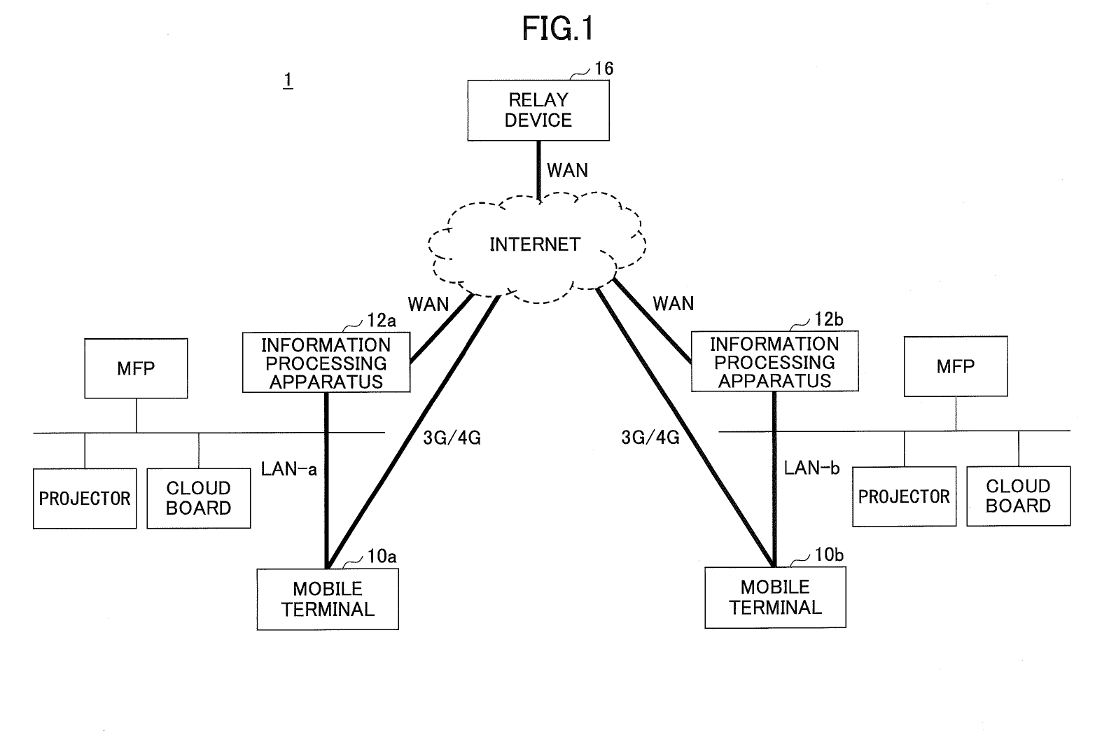

FIG. 1 illustrates a configuration of an example of an information processing system according to the present embodiment. An information processing system 1 illustrated in FIG. 1 includes mobile terminals 10a, 10b, information processing apparatuses 12a, 12b, and a relay device 16, which are connected by various networks. Note that the mobile terminals 10a, 10b may simply be referred to as the mobile terminal 10 when neither needs to be specified. Furthermore, the information processing apparatuses 12a, 12b may simply be referred to as the information processing apparatus 12 when neither needs to be specified.

The relay device 16 is connected to a network such as the Internet and WAN (Wide Area Network). The relay device 16 has a relaying role of connecting the mobile terminal 10a, the mobile terminal 10b, the information processing apparatus 12a, and the information processing apparatus 12b, which are connected to different LANs (Local Area Networks).

For example, in the example of the information processing system 1 of FIG. 1, the mobile terminal 10a and the information processing apparatus 12a are present in the same LAN-a, and the mobile terminal 10b and the information processing apparatus 12b are present in the same LAN-b. For example, the mobile terminal 10a and the information processing apparatus 12a are not present in the same LAN-b as the information processing apparatus 12b, and therefore the mobile terminal 10a and the information processing apparatus 12a connect with the information processing apparatus 12b via the relay device 16.

When the mobile terminal 10a or the information processing apparatus 12a has a request to the information processing apparatus 12b, the mobile terminal 10a or the information processing apparatus 12a sends, to the relay device 16, information (device number, network address, device name, etc.) for identifying itself (the mobile terminal 10a or the information processing apparatus 12a), the request, and information (device number, network address, device name, etc.) for identifying the information processing apparatus 12b. The relay device 16 stores the received request in a queue, in association with the information for identifying the information processing apparatus 12b and the information for identifying the device that has sent the request (here, information for identifying the mobile terminal 10a or the information processing apparatus 12a). The information processing apparatus 12b acquires, by polling, the request and the information for identifying the device that has sent the request, stored in the relay device 16. The information processing apparatus 12b performs the process according to the request, and sends, to the relay device 16, the process result together with the information for identifying the device that has sent the request. The relay device 16 stores the received process result in association with the information for identifying the device that has sent the request, and the mobile terminal 10a or the information processing apparatus 12a that has made the request is able to acquire, from the relay device 16, the process result in response to the request that has been sent to the relay device 16.

The information processing apparatus 12 receives a request by a general-purpose protocol such as a HTTP(S) request. The information processing apparatus 12 processes the received request and outputs the result. The information processing apparatus 12 connects to the relay device 16 at predetermined intervals, and confirms whether a request to itself is stored in the relay device 16.

When a request to itself is stored in the relay device 16, the information processing apparatus 12 acquires the request from the relay device 16. The information processing apparatus 12 executes a process according to the acquired request, such as converting the file format, printing, fax transmission, mail transmission, send a process instruction (print instruction, projection instruction, display instruction) to another electronic device (a projector, a MFP, a cloud board), etc., and returns the process result and necessary data to the relay device 16. Note that the information processing apparatus 12 performs communication with the registered mobile terminal 10, but does not perform communication with a mobile terminal 10 that is not registered.

Furthermore, the mobile terminal 10 is an example of a terminal device operated by the user. The mobile terminal 10 is, for example, a smartphone, a tablet terminal, a mobile phone, etc. For example, the mobile terminal 10 displays a list of files stored by the information processing apparatus 12 and the contents of the files. The mobile terminal 10 may also receive setting changes with respect to the information processing apparatus 12. Note that when the mobile terminal 10 receives setting changes with respect to the information processing apparatus 12, the mobile terminal 10 receives the setting changes in consideration of user authority.

The mobile terminal 10 may register itself in the information processing apparatus 12. The mobile terminal 10 is able to communicate with the information processing apparatus 12 in which the mobile terminal 10 itself is registered, via various networks. The mobile terminal 10 may register itself in a plurality of information processing apparatuses 12. Note that the mobile terminal 10 may manage the plurality of information processing apparatuses 12 in which the mobile terminal 10 itself is registered, according to priority levels. The mobile terminal 10 is set to automatically connect with the information processing apparatus 12 having the highest priority level. Furthermore, the next time the mobile terminal 10 registers itself in an information processing apparatus 12, the mobile terminal 10 acquires, from the information processing apparatus 12, information for identifying the information processing apparatus 12, and stores the acquired information. Therefore, as described above, the mobile terminal 10 is able to send a request to the information processing apparatus 12 in which the mobile terminal 10 itself is registered, via the relay device 16.

In FIG. 1, when the mobile terminal 10 connects with the information processing apparatus 12, the connection may be made by LAN (Local Area Network) connection using LAN-a, LAN-b, or mobile connection using a data line (mobile phone line network) of a mobile network carrier such as 3G and 4G. Note that in mobile connection, the communication speed is often lower than that of LAN connection. As described above, the mobile terminal 10 is able to connect to two different networks.

Furthermore, even when the mobile terminal 10 cannot make a LAN connection with the information processing apparatus 12 that is the request destination, if there is an information processing apparatus 12 other than the request destination with which LAN connection is possible, the mobile terminal 10 may connect with, and connect with the information processing apparatus 12 that is the request destination via the information processing apparatus 12 other than the request destination.

For example, in the case of the information processing system 1 of FIG. 1, the mobile terminal 10a cannot make a LAN connection with the information processing apparatus 12b that is the request destination, but can make a LAN connection with the information processing apparatus 12a, and therefore the mobile terminal 10a can connect with the information processing apparatus 12b via the information processing apparatus 12a.

Note that it is determined as to whether the mobile terminal 10 is to make a mobile connection with the information processing apparatus 12 that is the request destination, or to connect with the information processing apparatus 12 that is the request destination via an information processing apparatus 12 other than the request destination, based on the connection speed of the respective lines, as described below.

The information processing system 1 illustrated in FIG. 1 is one example; the relay device 16 may be distributed across a plurality of computers. Furthermore, in the example of FIG. 1, there are two information processing apparatuses 12; however, there may be three or more information processing apparatuses 12. Furthermore, in the example of FIG. 1, there are two mobile terminals 10; however, there may be one or more mobile terminals 10. Furthermore, in the information processing system 1 illustrated in FIG. 1, only the elements necessary for describing the present embodiment are indicated, but the information processing system 1 may include other elements. As described above, the information processing system 1 illustrated in FIG. 1 is one example, and there may be various examples of system configurations according to the purpose and objective.

### <Hardware Configuration>

<<Computer>>

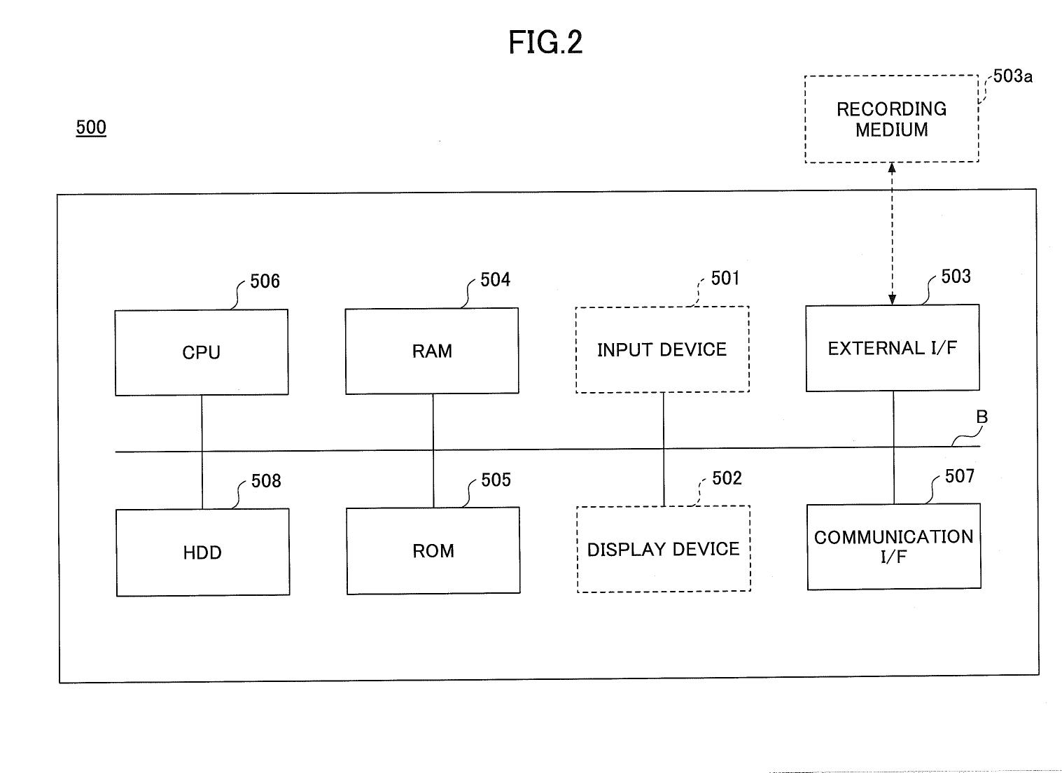

The information processing apparatus 12 and the relay device 16 are realized by a computer having a hardware configuration, for example, as illustrated in FIG. 2. FIG. 2 illustrates a hardware configuration of an example of a computer according to the present embodiment.

A computer 500 illustrated in FIG. 2 includes an input device 501, a display device 502, an external I/F 503, a RAM 504, a ROM 505, a CPU 506, a communication I/F 507, and a HDD 508, which are interconnected by a bus B. Note that the input device 501 and the display device 502 may have a configuration of being connected and used when necessary.

The input device 501 includes a keyboard, a mouse, and a touch panel, and is used by the user for inputting various operation signals. The display device 502 includes a display, etc., and displays processing results obtained by the computer 500.

The communication I/F 507 is an interface that connects the computer 500 to various networks. Accordingly, the computer 500 is able to perform data communication via the communication I/F 507.

Furthermore, the HDD 508 is an example of a non-volatile storage device for storing programs and data. The stored programs and data include an OS that is the basic software for controlling the entire computer 500, and application software (hereinafter, simply referred to as “application”) for providing various functions in the OS. Note that the computer 500 may use a drive device (for example, a solid state drive: SSD) using a flash memory as the storage medium, instead of the HDD 508.

The external I/F 503 is an interface between the computer 500 and an external device. An example of the external device is a recording medium 503a. Accordingly, the computer 500 is able to read and/or write in the recording medium 503a via the external I/F 503. Examples of the recording medium 503a are a flexible disk, a CD, a DVD, an SD memory card, and a USB memory.

The ROM 505 is an example of a non-volatile semiconductor memory (storage device) that can store programs and data even after the power is turned off. The ROM 505 stores programs and data such as a BIOS that is executed when the computer 500 is activated, OS settings, and network settings. The RAM 504 is an example of a volatile semiconductor memory (storage device) for temporarily storing programs and data.

The CPU 506 is a processor for controlling the entire computer 500 and realizing functions of the computer 500, by loading the programs and data from the storage devices such as the ROM 505 and the HDD 508, into the RAM 504, and executing processes.

The information processing apparatus 12 and the relay device 16 are able to realize various processes described below, by the hardware configuration of the computer 500, for example, illustrated in FIG. 2.

<<Mobile Terminal>>

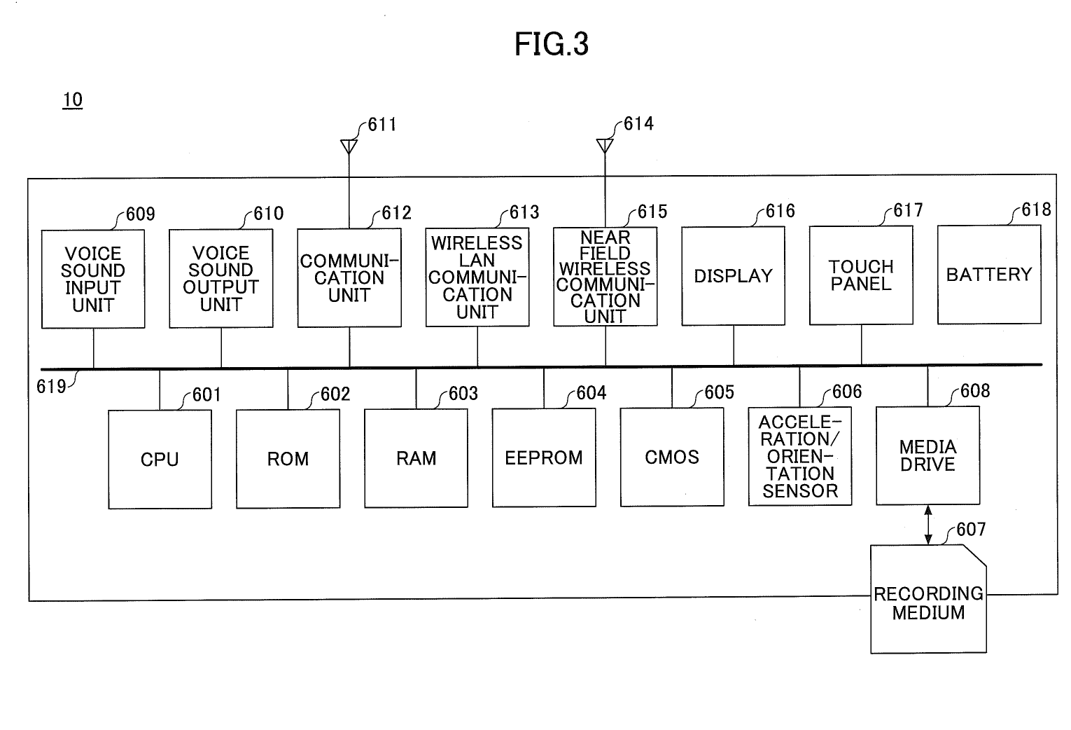

FIG. 3 illustrates a hardware configuration of an example of a mobile terminal according to the present embodiment. The mobile terminal 10 of FIG. 3 includes a CPU 601, a ROM 602, a RAM 603, an EEPROM 604, a CMOS sensor 605, an acceleration/orientation sensor 606, and a media drive 608.

The CPU 601 controls the operations of the entire mobile terminal 10. The ROM 602 stores the basic input output programs. The RAM 603 is used as a work area of the CPU 601. The EEPROM 604 reads or writes data according to control by the CPU 601. The CMOS sensor 605 obtains image data by capturing an image of a subject according to control by the CPU 601. The acceleration/orientation sensor 606 is an electromagnetic compass for detecting geomagnetism, gyrocompass, an acceleration sensor, etc.

The media drive 608 controls the reading or writing (storing) of data with respect to a recording medium 607 such as a flash memory, etc. In the media drive 608, the recording medium 607 can be freely attached/detached. Accordingly, data already recorded in the recording medium 607 can be read, and data can be newly written and stored in the recording medium 607.

Note that the EEPROM 604 stores the OS executed by the CPU 601 and association information necessary for network setting, etc. Applications for executing various processes according to an embodiment of the present invention, are stored in the EEPROM 604 or the recording medium 607, etc.

Furthermore, the CMOS sensor 605 is a charge-coupled device for computerizing the image of the subject, by converting light into charges. As long as the CMOS sensor 605 can capture images of the subject, the CMOS sensor 605 may be, for example, a CCD (charged-coupled device) sensor.

Furthermore, the mobile terminal 10 includes a voice sound input unit 609, a voice sound output unit 610, an antenna 611, a communication unit 612, a wireless LAN communication unit 613, a near field wireless communication antenna 614, a near field wireless communication unit 615, a display 616, a touch panel 617, and a bus line 619.

The voice sound input unit 609 converts voice sound into voice sound signals. The voice sound output unit 610 converts voice sound signals into voice sound. The communication unit 612 communicates with the nearest base station device by wireless communication signals by using the antenna 611. The wireless LAN communication unit 613 performs wireless LAN communication complying with the IEEE80411 standard with an access point. The near field wireless communication unit 615 performs near field wireless communication (Bluetooth (registered trademark) communication) by using the near field wireless communication antenna 614.

The display 616 is a liquid crystal, an organic EL, etc., for displaying an image of a subject, various icons, etc. The touch panel 617 is mounted on the display 616, and is constituted by a pressure-sensitive or an electrostatic panel, and detects the touch position on the display 616 when a user touches the display 616 with his/her finger, a touch pen, etc. The bus line 619 is an address bus, a data bus, etc., for electrically connecting the above units.

Furthermore, the mobile terminal 10 includes an exclusive-use battery 618. The mobile terminal 10 is driven by the battery 618. Note that the voice sound input unit 609 includes a microphone for inputting voice sound. The voice sound output unit 610 includes a speaker for outputting voice sound.

As described above, the mobile terminal 10 according to the present embodiment is able to realize various processes described below, by the above hardware configuration.

### <Software Configuration>

<<Mobile Terminal>>

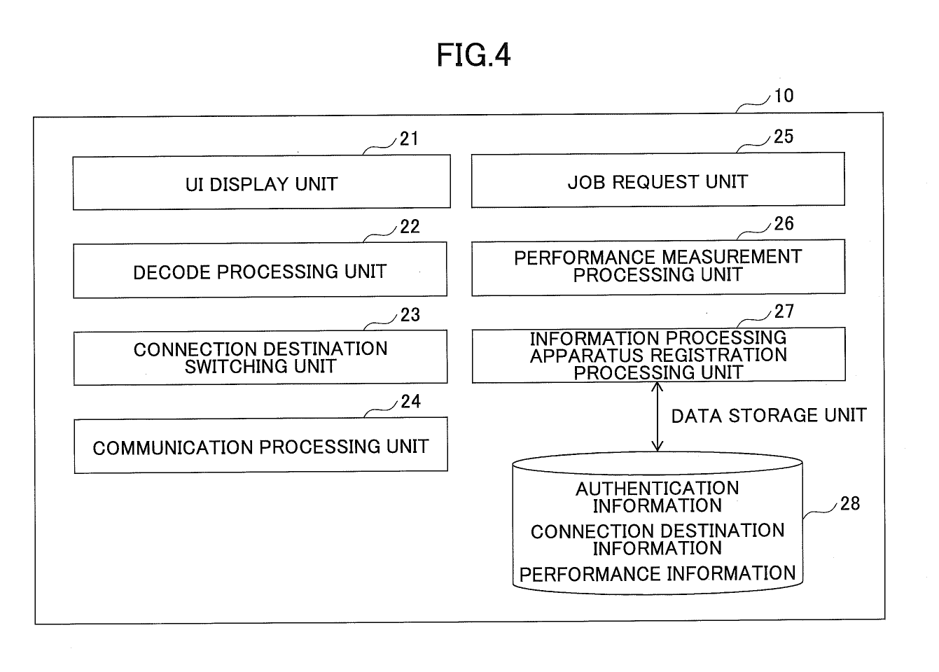

The mobile terminal 10 according to the present embodiment is constituted as, for example, illustrated in FIG. 4. FIG. 4 is a process block diagram of an example of the mobile terminal according to the present embodiment. The mobile terminal 10 realizes, by executing applications, a UI display unit 21, a decode processing unit 22, a connection destination switching unit 23, a communication processing unit 24, a job request unit 25, a performance measurement processing unit 26, an information processing apparatus registration processing unit 27, and a data storage unit 28.

The UI display unit 21 is a processing unit for controlling a GUI to be displayed to the user, and displays the contents of the mobile terminal 10 and registration information. Here, the contents include documents stored by the mobile terminal 10, file list information acquired from the information processing apparatus 12, files, etc. The registration information includes authentication information, connection destination information to the information processing apparatus 12, performance information obtained by measurement when connecting to the information processing apparatus 12, etc.

The decode processing unit 22 performs a process of decoding information such as a two-dimensional barcode displayed on the Web UI of the information processing apparatus 12. The two-dimensional barcode includes network information for connecting to the information processing apparatus 12, ID information (the above-described information for identifying the information processing apparatus 12) for uniquely identifying the information processing apparatus 12, etc. The decoded information is managed as connection destination information (registration information).

The information processing apparatus registration processing unit 27 establishes connection with the information processing apparatus 12 based on information acquired by the decode processing unit 22, and when there is no problem in the connection, the information processing apparatus registration processing unit 27 registers the necessary information in the data storage unit 28. The connection with the information processing apparatus 12 is confirmed with respect to LAN connection and mobile connection described above. The performance measurement processing unit 26 reports a transmission trigger of dummy data to the information processing apparatus 12 at the stage when the connection with the information processing apparatus 12 is established, and measures the time until dummy data is received from the information processing apparatus 12.

The performance measurement processing unit 26 measures the time until dummy data is received from the information processing apparatus 12, with respect to both a line for making a mobile connection with the information processing apparatus 12 that is the request destination, and a line for making a LAN connection with the information processing apparatus 12 other than the request destination. The performance measurement processing unit 26 stores the result of measurement as performance information in the data storage unit 28.

The performance information is used as comparison data when the mobile terminal 10 switches between mobile connection with the information processing apparatus 12 that is the request destination and LAN connection with the information processing apparatus 12 other than the request destination. Note that the quality of the line used for communication may be constantly changed and improved. For example, as the radio wave condition changes according to the position of the mobile terminal 10, the quality of the line used for communication may change. As the communication environment that can be used changes according to the contract with a telecom carrier, the quality of the line used for communication may be improved or may be degraded.

Therefore, the measurement by the performance measurement processing unit 26 is performed not only when registering in the information processing apparatus 12, but also when communicating with the information processing apparatus 12, such that the performance information in the data storage unit 28 is constantly updated.

The job request unit 25 creates a request message when acquiring a file list, a file, etc., from the information processing apparatus 12. When acquiring a file list of the information processing apparatus 12, the job request unit 25 creates a message of a file list acquisition request, and sends message to the information processing apparatus 12 via the communication processing unit 24.

The connection destination switching unit 23 selects, as the connection destination, any one of LAN connection, mobile connection or, connection via an information processing apparatus 12 other than the request destination, when connecting with the information processing apparatus 12 that is the request destination.

When the mobile terminal 10 is able connect to the same LAN as that of the information processing apparatus 12 that is the request destination, the connection destination switching unit 23 selects LAN connection (direct connection) with the information processing apparatus 12 that is the request destination. When the mobile terminal 10 is unable connect to the same LAN as that of the information processing apparatus 12 that is the request destination, the connection destination switching unit 23 determines whether it is possible to connect to the same LAN as the information processing apparatus 12 other than the request destination.

When the mobile terminal 10 is unable to connect to the same LAN as the information processing apparatus 12 other than the request destination, the connection destination switching unit 23 selects mobile connection with the information processing apparatus 12 that is the request destination. When the mobile terminal 10 is able to connect to the same LAN as the information processing apparatus 12 other than the request destination, the connection destination switching unit 23 compares the performance information of connection via the information processing apparatus 12 other than the request destination with the performance information of mobile connection with the information processing apparatus 12 that is the request destination, and selects the connection destination with superior performance.

<<Information Processing Apparatus>>

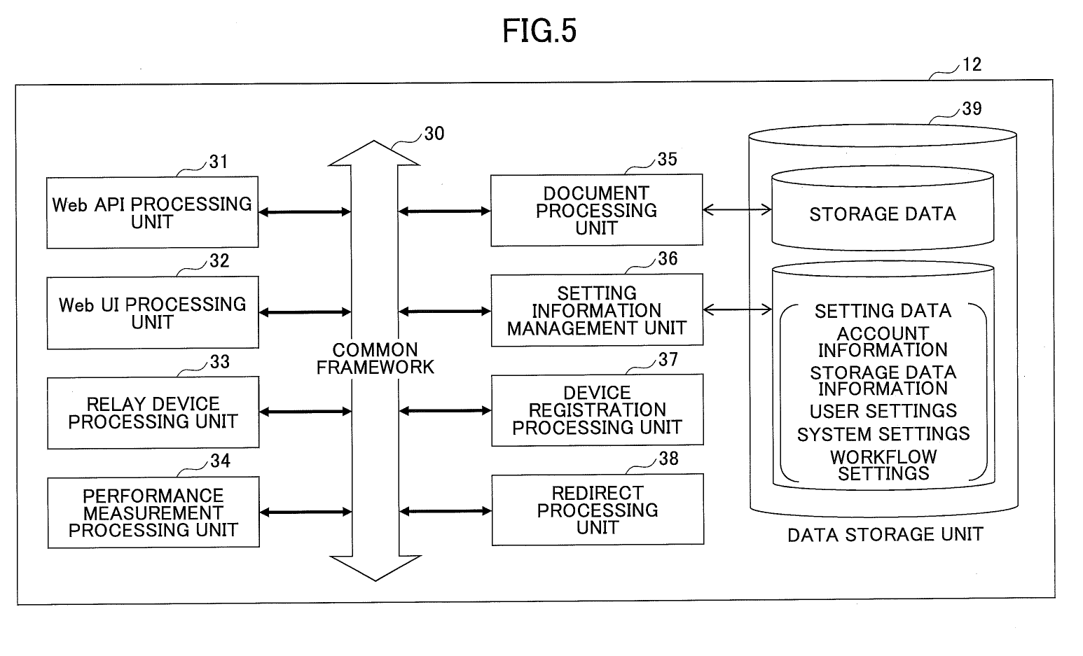

The information processing apparatus 12 according to the present embodiment is constituted, for example, as illustrated in FIG. 5. FIG. 5 is a process block diagram of an example of the information processing apparatus according to the present embodiment. The information processing apparatus 12 realizes, by executing programs, a common framework 30, a web API processing unit 31, web UI processing unit 32, a relay device processing unit 33, a performance measurement processing unit 34, a document processing unit 35, a setting information management unit 36, a device registration processing unit 37, a redirect processing unit 38, and a data storage unit 39.

The common framework 30 is a mechanism for a plurality of software items in the information processing apparatus 12 to perform communication, and is used for transmitting and receiving requests and data. The web API processing unit 31 controls HTTP(S) requests via the web API, from the mobile terminal 10 and electronic devices (not illustrated) connected to the network.

The Web API (Application Programming Interface) is an interface that is defined in advance and provided for receiving requests from the mobile terminal 10 and electronic devices (a MFP, a projector, a cloud board, etc.), and is constituted by, for example, functions and classes. The web API processing unit 31 sends the received request to the respective processing units via the common framework 30, after serializing the request according to each request source.

Furthermore, the web UI processing unit 32 controls the display contents of the web server included in the information processing apparatus 12. The web UI processing unit 32 constructs display contents according to the setting information and the file contents for each user. The relay device processing unit 33 monitors whether there is a request stored in the relay device 16 at predetermined intervals. When there is a request stored in the relay device 16, the relay device processing unit 33 acquires the request from the relay device 16 and sends the request to the respective processing units. Furthermore, the relay device processing unit 33 receives, from the respective processing units, the process results in response to the request sent to the respective processing units, and reports the process results to the relay device 16.

The performance measurement processing unit 34 measures the performance of connection with the registered mobile terminal 10, and manages the result as one of the registration information items of the mobile terminal 10. The performance measurement processing unit 34 performs transmission and reception of dummy data with the mobile terminal 10, and measures the performance relevant to the data transmission and reception. The performance relevant to the data transmission and reception is measured according to the elapsed time from when a transmission trigger of dummy data is sent to the information processing apparatus 12 as a trigger for starting measurement from the mobile terminal 10, until the mobile terminal 10 receives the dummy data from the information processing apparatus 12.

The document processing unit 35 manages the file stored in the information processing apparatus 12 as storage data. The storage data is a file stored in the data storage unit 39 via SMB, a file created by the information processing apparatus 12, etc. The document processing unit 35 also performs format conversion of the stored data, other than managing the stored data.

The format conversion of the stored data includes converting the image format, converting from a particular application format, etc. The document processing unit 35 also manages the storage data that has undergone format conversion.

The setting information management unit 36 manages, for example, account information, storage data information, user settings, system settings, and workflow settings, as setting information in the data storage unit 39. The setting information includes the setting information of the user and the setting information of the system. Note that the account information includes information for identifying the registered mobile terminal 10, identification information of a user using each mobile terminal 10 (user name, user unique number), authentication information of each user (ID, password, etc.). The storage data information includes the data format and the data name of each storage data item stored in the information processing apparatus 12, the data amount, the update time and date, the type of converted data format, the file browsing date of each user (or each mobile terminal), etc. The user setting includes information relevant to a unique setting of each of the above users, etc. The setting information of the system includes information unique to the device, settings common to all users, etc.

The device registration processing unit 37 is a processing unit for registering the mobile terminal 10. The device registration processing unit 37 displays, via a web UI, a two-dimensional barcode, etc., including information needed for device registration. The mobile terminal 10 reads, with a camera function, for example, a two-dimensional barcode displayed on the web UI of the information processing apparatus 12, and decodes the two-dimensional barcode, to acquire information for connecting to the information processing apparatus 12.

The redirect processing unit 38 transfers a request addressed to another information processing apparatus 12, to the other information processing apparatus 12, when the request addressed to the other information processing apparatus 12 is received from the mobile terminal 10 that is LAN-connected.

The redirect processing unit 38 receives information of another information processing apparatus 12 with which communication is to be made, together with a redirect request (transfer request) from the mobile terminal 10, such that the redirect processing unit 38 is able to transfer the request addressed to the other information processing apparatus 12 to the other information processing apparatus 12.

This redirect processing unit 38 is used in a case where connection via an information processing apparatus 12 other than the request destination is selected, as a connection destination having superior performance at the connection destination switching unit 23 of the mobile terminal 10.

### <Details of Process>

In the following, a description is given of details of the process by the information processing system 1 according to the present embodiment.

<<Registration of Information Processing Apparatus>>

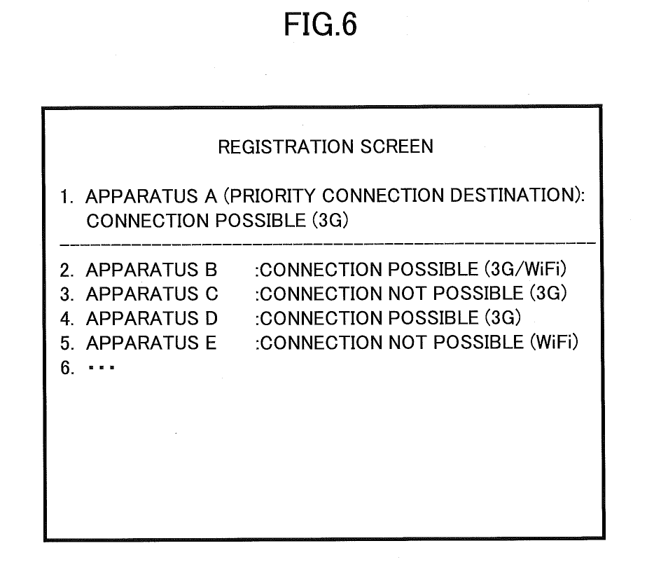

FIG. 6 is an image diagram of an example of a registration screen of the information processing apparatus 12 displayed on the mobile terminal 10. The registration screen of FIG. 6 displays a list of information processing apparatuses 12 that are already registered. Note that in the registration screen of FIG. 6, the state of connection possible/connection not possible is displayed for each information processing apparatus 12 that has been registered. By referring to the registration screen of FIG. 6, the user is able to recognize whether the information processing apparatus 12 that has been registered is in a state of connection possible or connection not possible.

Furthermore, the registration screen of FIG. 6 displays, for each of the information processing apparatuses 12 that has been registered, the connection line by which the corresponding information processing apparatus 12 can be connected, such as LAN connection such as WiFi (registered trademark), and mobile connection using a data line of a mobile network carrier such as 3G.

For example, the mobile terminal 10 connects with the relay device 16 when activating an application, and can recognize the information processing apparatus 12 that is accessing the relay device 16. That is to say, the mobile terminal 10 is able to recognize the activation state of the information processing apparatus 12.

When connecting with the relay device 16, the mobile terminal 10 sends a list of information processing apparatuses 12 registered in the mobile terminal 10, and then the mobile terminal 10 receives, from the relay device 16, a list of information processing apparatuses 12 with which the mobile terminal 10 can access at that time point. The list of information processing apparatuses 12 received from the relay device 16 corresponds to a list of information processing apparatuses 12 with which mobile connection can be made from the mobile terminal 10.

Furthermore, when there is a change in the network state (mainly LAN connection), the mobile terminal 10 searches for an information processing apparatus 12 in the same network. The searching can be performed by using device searching according to a general-purpose protocol such as UPnP (Universal Plug and Play).

Note that it is also assumed that the power of the information processing apparatus 12 may be turned off; however, the information processing apparatus 12 also has a function of reporting activation by a general-purpose protocol such as UPnP, when the power is turned on. Therefore, the power of the information processing apparatus 12 does not necessarily need to be turned on, at the time point when the mobile terminal 10 starts the search.

A list of information processing apparatuses 12 that are confirmed to be activated in the same network and that are registered in the mobile terminal 10, corresponds to a list of information processing apparatuses 12 with which LAN connection (direction connection) can be made from the mobile terminal 10 or with which connection can be made from the mobile terminal 10 via an information processing apparatus 12 other that the request destination.

The registration screen of FIG. 6 displays that connection is possible when any one of mobile connection, LAN connection, or a connection via an information processing apparatus 12 other that the request destination, is possible, and also displays the line that can be used, such as WiFi (registered trademark) and 3G. In the registration screen of FIG. 6, the information processing apparatus 12 with which connection is not possible is greyed out, and indications that connection is not possible and the line last used for connection are also displayed with respect to the corresponding information processing apparatus 12.

In the registration screen of the mobile terminal 10, it is possible to set the information processing apparatus 12 with which connection is to be made with high priority (priority connection destination). The information processing apparatus 12 of the priority connection destination, is an information processing apparatus 12 that is selected by default, when the file list is displayed at the mobile terminal 10. In the registration screen of FIG. 6, the information processing apparatus 12 identified by “apparatus A”, is the priority connection destination. The information processing apparatus 12 of the priority connection destination, is the information processing apparatus 12 with which connection is automatically made, when the user performs an operation of acquiring the file list.

In the registration screen of FIG. 6, other than the information processing apparatus 12 of the priority connection destination, the information processing apparatuses 12 that are numbered by number two and onward are also displayed. Note that in the registration screen of FIG. 6, the information processing apparatus 12 numbered by a small number has high priority. As described above, the left side of the registration screen of FIG. 6 indicates the priority level of the information processing apparatuses 12.

Note that even if the mobile terminal 10 is able to make mobile connection with the information processing apparatus 12 of the priority connection destination, if the mobile terminal 10 is also able to make LAN connection with another information processing apparatus 12, the mobile terminal 10 makes LAN connection with the information processing apparatus 12 of the highest priority.

As described above, when the mobile terminal 10 according to the present embodiment is able to make mobile connection with the information processing apparatus 12 of the priority connection destination, and is also able to make LAN connection with another information processing apparatus 12, the mobile terminal 10 is able to communicate with the information processing apparatus 12 of the priority connection destination via the other information processing apparatus 12.

<<Acquisition of File List>>

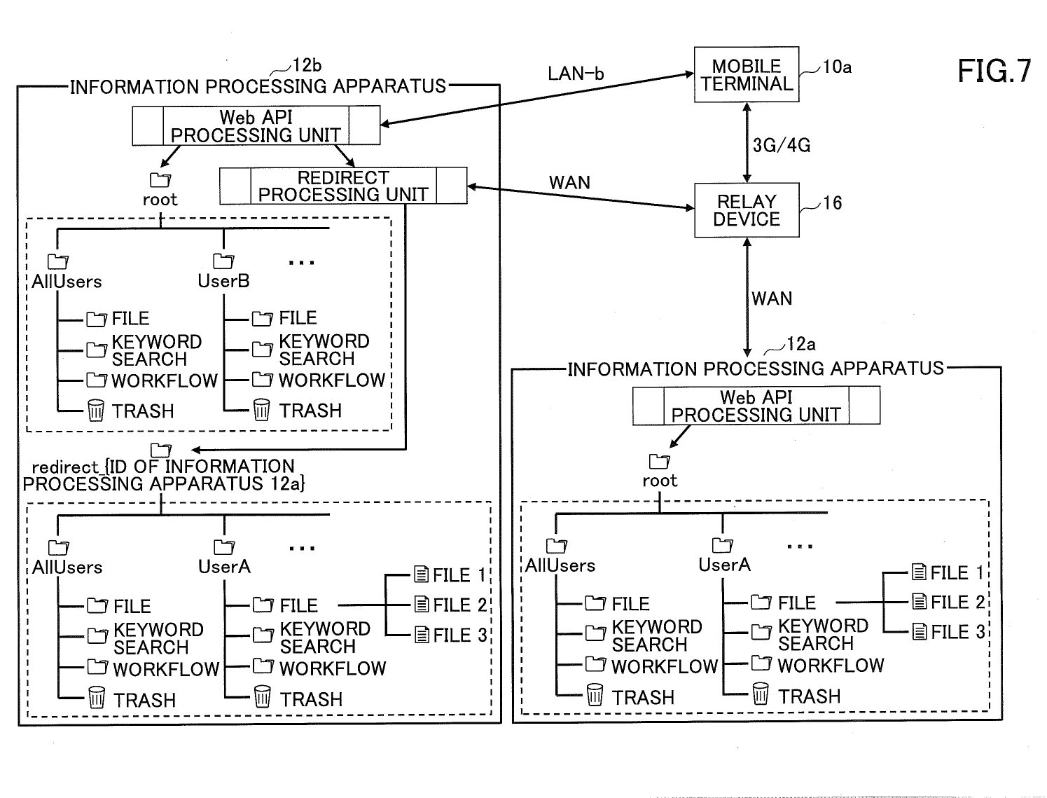

FIG. 7 is an image diagram of an example of a process of acquiring a file list from the information processing apparatus 12 by the mobile terminal 10. FIG. 7 indicates an example in which, after the mobile terminal 10a moves from the network environment of LAN-a to the network environment of LAN-b, the mobile terminal 10a acquires a file list from the information processing apparatus 12a via the information processing apparatus 12b.

In FIG. 7, the mobile terminal 10a is able to make LAN connection with the information processing apparatus 12a, and is also able to make LAN connection with the information processing apparatus 12b. Note that the mobile terminal 10a, the information processing apparatus 12a, and the information processing apparatus 12b are registered in each other. In the mobile terminal 10a, the information processing apparatus 12a is registered as the priority connection destination; and the information processing apparatus 12b is registered as having a priority level next to the priority connection destination, with which LAN connection is possible.

When the mobile terminal 10a moves and enters the same network environment of LAN-b as that of the information processing apparatus 12b, the mobile terminal 10a searches for the information processing apparatus 12b present in LAN-b, and recognizes that connection is possible with the information processing apparatus 12b.

The mobile terminal 10a has the performance information stored in the data storage unit 28, and therefore compares the communication speed of mobile connection with the information processing apparatus 12a with the communication speed of LAN connection with the information processing apparatus 12b, and selects the superior connection destination. For example, when the communication speed of LAN connection with the information processing apparatus 12b is higher, the mobile terminal 10a selects LAN connection with the information processing apparatus 12b. Here, a description is given, assuming that LAN connection with the information processing apparatus 12b is selected.

In order to acquire a file list of the information processing apparatus 12a, the mobile terminal 10a uses LAN connection to send, to the information processing apparatus 12b, the information of the information processing apparatus 12a, together with a file list acquisition request and a redirect request. Note that information of the information processing apparatus 12a includes the network address of the information processing apparatus 12a and an ID for uniquely identifying the device.

When the redirect request is received from the mobile terminal 10a, the information processing apparatus 12b converts the file list acquisition request into a file list acquisition request to the information processing apparatus 12a, and sends the converted file list acquisition request to the information processing apparatus 12a via the relay device 16. When the information processing apparatus 12a receives the redirected (transferred) file list acquisition request from the information processing apparatus 12b, the information processing apparatus 12a performs the process corresponding to the file list acquisition request, and returns the process result to the information processing apparatus 12b that is the request source.

When the process result of the file list acquisition request is received, the information processing apparatus 12b stores the process result as cache data of the file list of the information processing apparatus 12a, in the data storage unit 39 of the information processing apparatus 12b. The cache data is managed by the document processing unit 35. Furthermore, the information processing apparatus 12b also performs a process similar to that for the file list acquisition request, with respect to a content data acquisition request. Note that the data storage unit 39 stores the cache data for a predetermined period.

The predetermined period may be, for example, after a certain time passes from when the information processing apparatus 12b receives the first file list acquisition request, after a certain time passes from the last time the mobile terminal 10a sends a request to the information processing apparatus 12a via the information processing apparatus 12b, after a certain time passes from when the connection (connection via LAN-b) between the information processing apparatus 12b and the mobile terminal 10a is disconnected, etc.

The information processing apparatus 12b stores the cache data in the data storage unit 39, and also returns the file list of the information processing apparatus 12a to the mobile terminal 10a, and the process result of the file list acquisition request to acquire the file list of the information processing apparatus 12a.

When the same request (file list acquisition request to acquire the file list of information processing apparatus 12a) is sent again from the mobile terminal 10a, the information processing apparatus 12b returns, to the mobile terminal 10a, the file list of the information processing apparatus 12a stored as cache data in the data storage unit 39. Therefore, in the information processing system 1 according to the present embodiment, the cache hit ratio increases with respect to a process that is frequently requested, and therefore even higher speed can be expected.

Note that when an information processing apparatus 12 is not present in the same network environment, the mobile terminal 10a communicates with the information processing apparatus 12a by mobile connection, using a data line of a mobile network carrier such as 3G.

Furthermore, after sending the acquired file list to the mobile terminal 10a, the information processing apparatus 12b may automatically acquire the file itself from the information processing apparatus 12a. The information processing apparatus 12b sends, to the information processing apparatus 12a, a request to acquire each of the files (file 1, file 2, file 3, . . . ) stored in the information processing apparatus 12a, based on information of the file list stored as cache data. Then, the information processing apparatus 12b stores the file received from the information processing apparatus 12a in response to the sent request to acquire the file, as cache data in the data storage unit 39.

Accordingly, when a request to acquire “file 1” is sent to the information processing apparatus 12b from the mobile terminal 10a which has acquired the file list, the information processing apparatus 12b sends “file 1” stored in the data storage unit 39 as cache data, to the mobile terminal 10a.

By the above configuration, it is possible to send a file to the mobile terminal 10a at a higher speed compared to the case where the information processing apparatus 12b sequentially sends a file acquisition request to the information processing apparatus 12a in response to a file acquisition request from the mobile terminal 10a.

Furthermore, for example, it is assumed that the user A folder is a folder that only the mobile terminal 10a (or the user using the mobile terminal 10a) is able to browse and acquire the files, and the All Users folder is a folder that the mobile terminal 10a and the mobile terminal 10b are able to browse and acquire the files. At this time, it is assumed that the mobile terminal 10a has executed a process of moving “file 1” stored in the user A folder of the information processing apparatus 12a, to the All Users folder of the information processing apparatus 12b. Then, as “file 1” is already stored in the information processing apparatus 12b, “file 1” can be quickly moved. Therefore, the mobile terminal 10b and the mobile terminal 10a are able to quickly share the file.

Furthermore, as for the order of the file acquisition requests that are automatically sent from the information processing apparatus 12b to the information processing apparatus 12a, for example, the files may be acquired in a descending order of how recent the file browsing date is, of browsing the file from the mobile terminal 10a stored in the information processing apparatus 12a, in a descending order of how recent the file update date is, in an alphabetical order of the name of the file, etc.

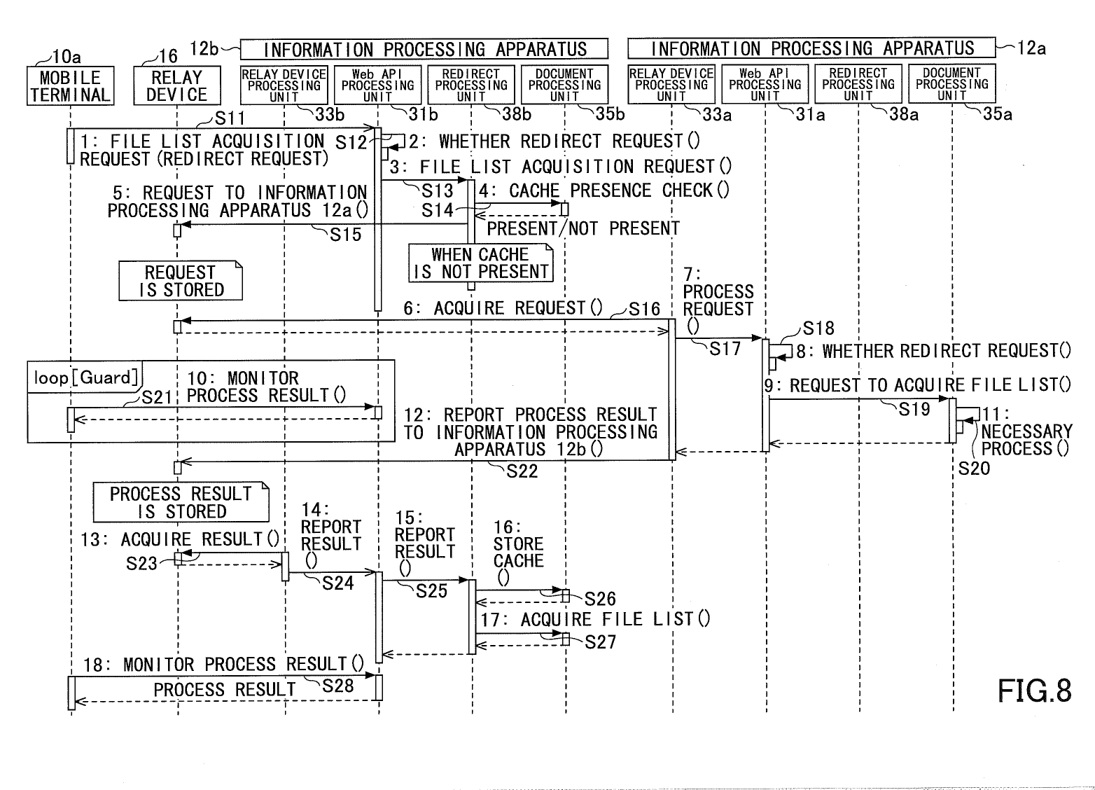

The process illustrated in FIG. 7 is performed, for example, by the procedures illustrated in FIG. 8. FIG. 8 is a sequence diagram of an example of a process of acquiring a file list from the information processing apparatus 12 by the mobile terminal 10. Note that the sequence diagram of FIG. 8 illustrates a process that is performed after LAN connection with the information processing apparatus 12b has been selected.

In step S11, in order to acquire a file list of the information processing apparatus 12a, the mobile terminal 10a sends, to the information processing apparatus 12b, the information of the information processing apparatus 12a together with a file list acquisition request and a redirect request, by using LAN connection.

The Web API processing unit 31b of the information processing apparatus 12b receives the information of the information processing apparatus 12a together with the file list acquisition request and the redirect request, from the mobile terminal 10a. In step S12, the Web API processing unit 31b determines whether a redirect request has been received. Here, the redirect request has been received from the mobile terminal 10a, and therefore the Web API processing unit 31b determines that a redirect request has been received.

In step S13, the Web API processing unit 31b sends a file list acquisition request to acquire the file list of the information processing apparatus 12a, to the redirect processing unit 38b. In step S14, the redirect processing unit 38b causes the document processing unit 35b to determine whether the file list of the information processing apparatus 12a is stored as cache data in the data storage unit 39. The document processing unit 35b returns, to the redirect processing unit 38b, the result of the cache presence check (present/not present) of whether the file list of the information processing apparatus 12a is stored as cache data in the data storage unit 39.

The sequence diagram of FIG. 8 indicates an example where the result of the cache presence check is “not present”. Note that when the result of the cache presence check is “present”, the file list of the information processing apparatus 12a stored as cache data in the data storage unit 39b, is returned to the mobile terminal 10.

In step S15, the redirect processing unit 38b converts the file list acquisition request from the mobile terminal 10a, into a file list acquisition request to the information processing apparatus 12a, and sends the converted file list acquisition request to the relay device 16. The relay device 16 stores the received file list acquisition request to the information processing apparatus 12a.

In step S16, the relay device processing unit 33a of the information processing apparatus 12a acquires the file list acquisition request to the information processing apparatus 12a stored in the relay device 16, by polling, for example.

In step S17, the relay device processing unit 33a sends the file list acquisition request to the information processing apparatus 12a acquired from the relay device 16, to the Web API processing unit 31a. In step S18, the Web API processing unit 31a determines whether a redirect request has been received. Here, a redirect request has not been received from the relay device 16, and therefore the Web API processing unit 31a determines that a redirect request has not been received. In step S19, the Web API processing unit 31a requests the document processing unit 35a to acquire the file list.

In step S20, the document processing unit 35a performs a process necessary for acquiring a file list. Note that as indicated in step S21, the mobile terminal 10, which has given the file list acquisition request to acquire the file list of the information processing apparatus 12a, performs monitoring until a process result is returned to the Web API processing unit 31b of the information processing apparatus 12b.

In step S22, the relay device processing unit 33a of the information processing apparatus 12a returns, to the relay device 16, a list of storage data stored in the data storage unit 39a, as the process result in response to the file list acquisition request to the information processing apparatus 12a. The relay device 16 stores the process result received from the information processing apparatus 12a.

In step S23, the relay device processing unit 33b of the information processing apparatus 12b acquires the process result stored in the relay device 16, by polling, for example. In step S24, the relay device processing unit 33b sends the process result acquired from the relay device 16, to the Web API processing unit 31b.

In step S25, the Web API processing unit 31b reports the process result to the redirect processing unit 38b. In step S26, the redirect processing unit 38b causes the document processing unit 35b to perform a process of storing the file list of the information processing apparatus 12a as cache data in the data storage unit 39, based on the reported process result.

In step S27, the redirect processing unit 38b acquires the file list of the information processing apparatus 12a from the document processing unit 35b, and returns the file list to the Web API processing unit 31b. After the process result is returned to the Web API processing unit 31b of the information processing apparatus 12b, in step S28, the mobile terminal 10a can acquire the file list of the information processing apparatus 12a as the process result from the Web API processing unit 31b of the information processing apparatus 12b.

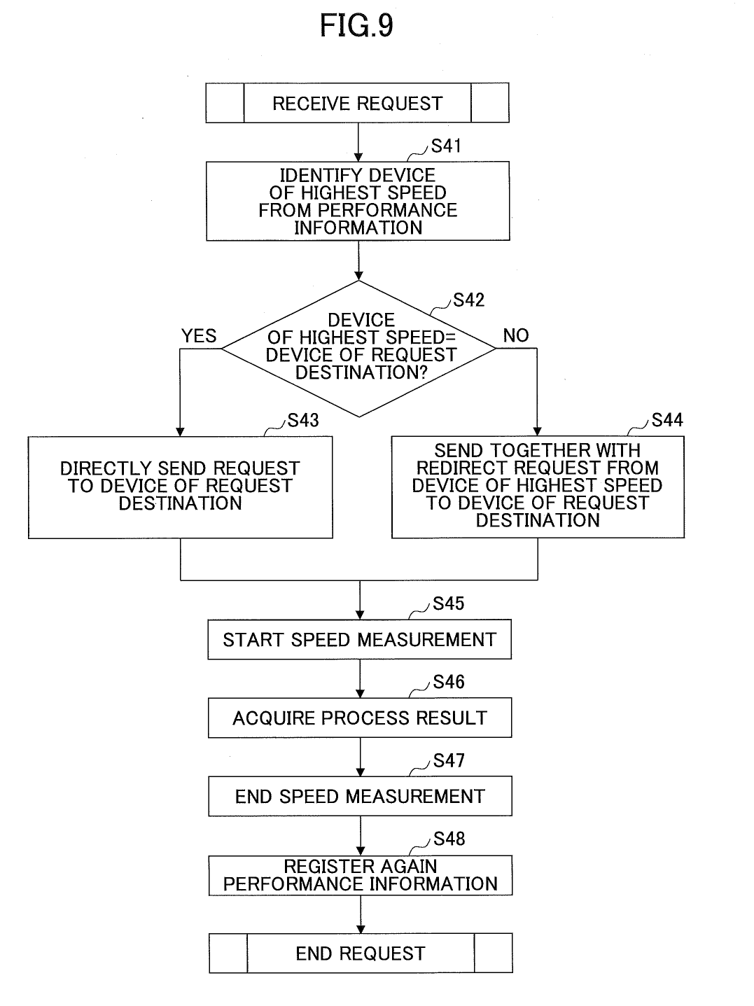

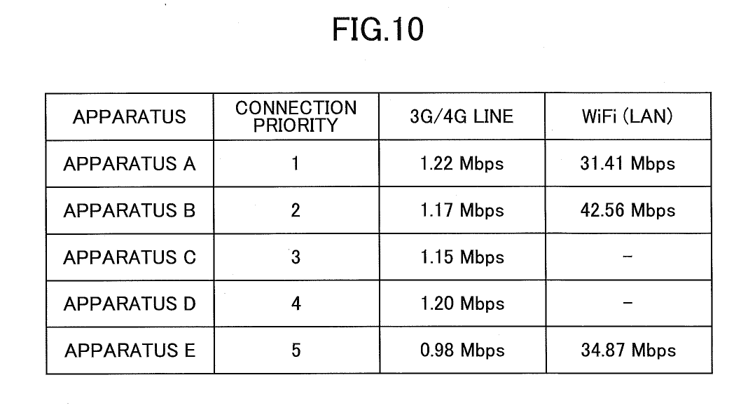

FIG. 9 is a flowchart of an example of a process of selecting the connection destination at the mobile terminal 10. In step S41, the connection destination switching unit 23 identifies a device (information processing apparatus 12) having the highest communication speed, from the performance information as illustrated in FIG. 10 stored in the data storage unit 28. FIG. 10 illustrates an example of performance information.

In the performance information of FIG. 10, the connection priority (priority level) and the communication speed of the connection destination are registered for each device. For example, in the case of the performance information of FIG. 10, in step S41, the connection destination switching unit 23 selects “apparatus B” as the device having the highest communication speed.

In step S42, the connection destination switching unit 23 determines whether the device that is the request destination is the same as “apparatus B” that is the device having the highest communication speed selected in step S41. When the device that is the request destination is the same as “apparatus B” that is the device having the highest communication speed, the connection destination switching unit 23 proceeds to step S43, and directly sends the request to “apparatus B” that is the request destination.

On the other hand, when the device that is the request destination is not the same as “apparatus B” that is the device having the highest communication speed, the connection destination switching unit 23 proceeds to step S44. The connection destination switching unit 23 sends a request to redirect to the device that is the request destination from “apparatus B” that is the device having the highest communication speed, together with a request to “apparatus B” that is the device having the highest communication speed.

After step S43 or S44, the process proceeds to step S45, and the performance measurement processing unit 26 starts measuring the communication speed. In step S46, the job request unit 25 acquires the process result from the device that is the request destination. In step S47, the performance measurement processing unit 26 ends measuring the communication speed. In step S48, the performance measurement processing unit 26 registers again (updates) the communication speed in the performance information as illustrated in FIG. 10, by the communication speed that is the result of the measurement.

The configuration of the information processing system 1 according to the present embodiment is one example, and there may be various system configuration examples according the purpose and objective.

### <Overview>

For example, in the information processing system 1 according to the present embodiment, there are information processing apparatuses 12a, 12b present at points A, B, respectively, at which different LANs (LAN-a, LAN-b) are constructed. In the information processing system 1 according to the present embodiment, the mobile terminal 10 present at point B acquires the data of the information processing apparatus 12a present at point A via the information processing apparatus 12b.

The mobile terminal 10 present at point B can communicate via the information processing apparatus 12b to connect with the information processing apparatus 12a present at a different point A by using LAN connection, and therefore the performance using a high speed line is expected to increase compared to the case of mobile connection.

Usually, when acquiring data by the mobile terminal 10 from an information processing apparatus 12 at a remote location, a data line of a mobile network carrier (3G, 4G, etc.) is used, and therefore the performance of data acquisition is low compared to the case of using a LAN line. However, in the information processing system 1 according to the present embodiment, the mobile terminal 10 makes a LAN connection with the information processing apparatus 12 that is the request destination via the information processing apparatus 12 in the same network as the mobile terminal 10, and therefore the performance of data acquisition increases compared to the case of using a mobile line.

Furthermore, in the information processing system 1 according to the present embodiment, the operability at the mobile terminal 10 is the same in the case of acquiring data of the information processing apparatus 12a at point A and in the case of acquiring data of the information processing apparatus 12b at point B, and therefore the usability is enhanced.

According to one embodiment of the present invention, a mobile terminal and an information processing system, are provided, which are capable of preventing the reduction in the speed of acquiring data.

The mobile terminal and the information processing system are not limited to the specific embodiments described herein, and variations and modifications may be made without departing from the spirit and scope of the present invention. Note that the connection destination switching unit 23 is an example of a connection destination switching unit. The communication processing unit 24 is an example of a communication processing unit. The performance measurement processing unit 26 is an example of a measurement processing unit. The redirect processing unit 38 is an example of a transfer processing unit.

The present application is based on and claims the benefit of priority of Japanese Priority Patent Application No. 2014-120391, filed on Jun. 11, 2014, the entire contents of which are hereby incorporated herein by reference.

What is claimed is:

1. A mobile terminal for acquiring data from an information processing apparatus, the mobile terminal comprising:
a connection destination switching unit configured to select a connection destination between a first line and a second line, when acquiring the data from a first information processing apparatus that is connected to a first network which is different from a network to which the mobile terminal is connected, the first line being connected to the first information processing apparatus via a second information processing apparatus connected to a second network that is the same as the network to which the mobile terminal is connected, and the second line being connected to the first information processing apparatus via a third network having a lower communication speed than that of the first line; and
a communication processing unit configured to send, to the second information processing apparatus, a data acquisition request including a transfer request to transfer to the first information processing apparatus, when the first line is selected as the connection destination, and receive, via the second information processing apparatus, a process result of a process executed at the first information processing apparatus in response to the data acquisition request.

2. The mobile terminal according to claim 1, wherein
the connection destination switching unit compares a communication speed of the first line and the second line, and selects the line having a higher communication speed as the connection destination.

3. The mobile terminal according to claim 1, further comprising:
a measurement processing unit configured to measure a communication speed of the first line and the second line, and store the measured communication speed in a data storage unit.

4. The mobile terminal according to claim 1, wherein
the first network and the second network are a local area network, and
the third network is a mobile phone line network.

5. A non-transitory computer-readable recording medium storing a program that causes a computer to execute a process performed in a mobile terminal for acquiring data from an information processing apparatus, the process comprising:
selecting a connection destination between a first line and a second line, when acquiring the data from a first information processing apparatus that is connected to a first network which is different from a network to which the mobile terminal is connected, the first line being connected to the first information processing apparatus via a second information processing apparatus connected to a second network that is the same as the network to which the mobile terminal is connected, and the second line being connected to the first information processing apparatus via a third network having a lower communication speed than that of the first line; and
sending, to the second information processing apparatus, a data acquisition request including a transfer request to transfer to the first information processing apparatus, when the first line is selected as the connection destination, and receiving, via the second information processing apparatus, a process result of a process executed at the first information processing apparatus in response to the data acquisition request.

6. An information processing system comprising a plurality of information processing apparatuses and a mobile terminal for acquiring data from one of the information processing apparatuses, wherein
the mobile terminal includes
a connection destination switching unit configured to select a connection destination between a first line and a second line, when acquiring the data from a first information processing apparatus that is connected to a first network which is different from a network to which the mobile terminal is connected, the first line being connected to the first information processing apparatus via a second information processing apparatus connected to a second network that is the same as the network to which the mobile terminal is connected, and the second line being connected to the first information processing apparatus via a third network having a lower communication speed than that of the first line, and
a communication processing unit configured to send, to the second information processing apparatus, a data acquisition request including a transfer request to transfer to the first information processing apparatus, when the first line is selected as the connection destination, and receive, via the second information processing apparatus, a process result of a process executed at the first information processing apparatus in response to the data acquisition request, wherein
the second information processing apparatus includes
a transfer processing unit configured to
transfer the data acquisition request to the first information processing apparatus,
receive, from the first information processing apparatus, the process result of the process executed at the first information processing apparatus in response to the data acquisition request, and
transfer the process result to the mobile terminal, when the second information processing apparatus receives, from the mobile terminal, the data acquisition request including the transfer request to transfer to the first information processing apparatus.

7. The information processing system according to claim 6, wherein
the transfer processing unit
stores, in a data storage unit, the process result received from the first information processing apparatus, and
transfers, to the mobile terminal, the process result stored in the data storage unit, when the process result for the data acquisition request received from the mobile terminal is stored in the data storage unit, when the data acquisition request including the transfer request to transfer to the first information processing apparatus is received from the mobile terminal.
